(19) United States
(12) Patent Application Publication
(10) Pub. No.: US 2015/0268993 A1
(43) Pub. Date: Sep. 24, 2015

(54) Method for Exploiting Parallelism in Nested Parallel Patterns in Task-based Systems

(71) Applicant: QUALCOMM Incorporated, San Diego, CA (US)

(72) Inventors: Pablo Montesinos Ortego, Fremont, CA (US); Michael Weber, Campbell, CA (US); Han Zhao, Sunnyvale, CA (US)

(21) Appl. No.: 14/336,288

(22) Filed: Jul. 21, 2014

Related U.S. Application Data
(60) Provisional application No. 61/968,720, filed on Mar. 21, 2014.

(51) Int. Cl. G06F 9/48; G06F 9/54

(52) U.S. Cl. CPC G06F 9/4881; G06F 9/54

(57) ABSTRACT

Aspects include computing devices, systems, and methods for task-based handling of nested repetitive processes in parallel. At least one processor of the computing device may be configured to partition iterations of an outer repetitive process and assign the partitions to initialized tasks to be executed in parallel by a plurality of processor cores. A shadow task may be initialized for each task to execute iterations of an inner repetitive process. Upon completing a task, divisible partitions of the outer repetitive process of ongoing tasks may be subpartitioned and assigned to the ongoing task, and the completed task and shadow task or a newly initialized task and shadow task. Upon completing all but one task and one iteration of the outer repetitive process, shadow tasks may be initialized to execute partitions of iterations of the inner repetitive process.

### RELATED APPLICATIONS

This application claims the benefit of priority to U.S. Provisional Application No. 61/968,720 entitled “Method for Exploiting Parallelism in Nested Parallel Patterns in Task-based Systems” filed Mar. 21, 2014, the entire contents of which are hereby incorporated by reference.

### BACKGROUND

A common concept in computer programming is the execution of one or more instructions repetitively according to a given criterion. This repetitive execution can be accomplished by programming using recursion, fixed point iteration, or looping constructs, such as nested loops. In various instances computer programs can include nested repetitions of processes, in which a first repetitive process may execute a certain number of times according to a criterion, and in one or more instances of the execution of the first repetitive process a second repetitive process can execute according to a criterion. In such an instance, if the first repetitive process criterion directs the first repetitive process to execute “n” number of times, and the second repetitive process criterion directs the second repetitive process to execute “m” number of times, the total number of executions of the repetitive processes can be as great as n*m executions.

In some computer systems with multiple processors or multi-core processors, execution of processes can be run in parallel with each other on the multiple processors or cores. Such parallel execution of repetitive processes can improve the performance of the computer system. For example, in a computer system with four or more processors or processor cores, if the first repetitive process criterion directs the first repetitive process to execute n number of times, n can be split into p divisions, for example n0, n1, n2, . . . np. The p divisions of n can each represent a subset of the number of times to execute the first repetitive process. The first repetitive process can be assigned to execute on respective processors or processor cores for one of the subsets n0, n1, n2, . . . np. Each of the processors or processor cores can also execute the second repetitive process within the first repetitive process for the subset of n to which they are assigned.

However, in many computer systems, this does not alleviate an issue with the overall overhead involved in executing nested repetitive processes. In a task-based run-time system, a separate task can be created for each execution of the p divisions of first repetitive process and the m iterations of the second repetitive processes, creating p*m tasks. The greater the number of tasks the greater an amount of overhead is created for managing all of the tasks.

### SUMMARY

The methods and apparatuses of various aspects provide circuits and methods for task-based handling of nested repetitive processes. An aspect method may include partitioning iterations of an outer repetitive process into a first plurality of outer partitions, initializing a first task for executing iterations of a first outer partition, initializing a first shadow task for executing iterations of an inner repetitive process for the first task, initializing a second task for executing iterations of a second outer partition, executing the first task by a first processor core and the second task by a second processor core in parallel, and executing the first shadow task for the iterations of the inner repetitive process each time a condition calls for executing the inner repetitive process upon availability of the second processor core and assignment to the second processor core.

An aspect method may further include completing execution of the second task, determining whether the first outer partition is divisible, and partitioning the first outer partition of the first task into a second plurality of outer partitions in response to determining that the first outer partition is divisible.

An aspect method may further include assigning a third outer partition of the second plurality of outer partitions to the first task, assigning a fourth outer partition of the second plurality of outer partitions to the second task, executing the first task on the third outer partition by the first processor core and the second task on the fourth outer partition by the second processor core in parallel, completing execution of the second task a subsequent time resulting in availability of the second processor core, and assigning the first shadow task to the second processor core.

An aspect method may further include discarding the second task, initializing a third task for executing iterations of a fourth outer partition of the second plurality of outer partitions, assigning a third outer partition of the second plurality of outer partitions to the first task, assigning the fourth outer partition of the second plurality of outer partitions to the third task, executing the first task on the third outer partition by the first processor core and the third task on the fourth outer partition by the second processor core in parallel, completing execution of the third task resulting in availability of the second processor core, and assigning the first shadow task to the second processor core.

In an aspect, completing execution of the second task results in availability of the second processor core, and an aspect method may further include determining whether the inner repetitive process of the first task is divisible in response to determining that the first outer partition of the outer repetitive process is indivisible, partitioning the iterations of the inner repetitive process into a first plurality of inner partitions in response to determining that the inner repetitive process of the first task is divisible, assigning the iterations of the inner repetitive process to the first shadow task, in which the iterations of the inner repetitive process comprise a first inner partition, and assigning the first shadow task to the second processor core.

An aspect method may further include initializing a second shadow task for executing the iterations of the inner repetitive process for the first task upon availability of a third processor core, assigning a second inner partition to the second shadow task, assigning the second shadow task to the third processor core, and executing the second shadow task for iterations of the second inner partition of the inner repetitive process each time a condition calls for executing the inner repetitive process.

An aspect method may further include partitioning the iterations of the inner repetitive process by a number of partitions equivalent to a number of available processor cores.

An aspect method may further include partitioning the iterations of the outer repetitive process by a number of partitions equivalent to a number of available processor cores.

An aspect method may further include initializing a first pointer for the first task, updating the first pointer to indicate the execution of the iterations of the inner repetitive process of the first outer partition, and checking the first pointer to determine an iteration of the inner repetitive process of the first outer partition for executing by the first shadow task.

An aspect includes a computing device having a plurality of processor cores in which at least one processor core is configured with processor-executable instructions to perform operations of one or more of the aspect methods described above.

An aspect includes a non-transitory processor-readable medium having stored thereon processor-executable software instructions to cause a plurality of processor cores to perform operations of one or more of the aspect methods described above.

An aspect includes a computing device having means for performing functions of one or more of the aspect methods described above.

### BRIEF DESCRIPTION OF THE DRAWINGS

The accompanying drawings, which are incorporated herein and constitute part of this specification, illustrate example aspects of the invention, and together with the general description given above and the detailed description given below, serve to explain the features of the invention.

FIG. 1 is a component block diagram of an example computing device suitable for implementing an aspect.

FIG. 2 is a component block diagram of an example multi-core processor suitable for implementing an aspect.

FIG. 3 is a functional and component block diagram of a system-on-chip suitable for implementing an aspect.

FIG. 4 is a graph diagram of task-based handling of nested repetitive processes, in accordance with an aspect.

FIG. 5 is a graph diagram of task-based handling of nested repetitive processes, in accordance with an aspect.

FIG. 6 is a graph diagram of task-based handling of nested repetitive processes, in accordance with an aspect.

FIG. 7 is a graph diagram of task-based handling of nested repetitive processes, in accordance with an aspect.

FIG. 8 is a graph diagram of task-based handling of nested repetitive processes, in accordance with an aspect.

FIG. 9 is a graph diagram of task-based handling of nested repetitive processes, in accordance with an aspect.

FIG. 10 is a graph diagram of task-based handling of nested repetitive processes, in accordance with an aspect.

FIG. 11 is a chart diagram of task-based handling of nested repetitive processes, in accordance with an aspect.

FIG. 12 is a process flow diagram illustrating an aspect method for task-based handling of nested repetitive processes.

FIG. 13 is a process flow diagram illustrating an aspect method for dividing a partition of outer repetitive process iterations into subpartitions in task-based handling of nested repetitive processes.

FIG. 14 is a process flow diagram illustrating an aspect method for dividing a partition of outer repetitive process iterations into subpartitions in task-based handling of nested repetitive processes.

FIG. 15 is a process flow diagram illustrating an aspect method for partitioning inner repetitive process iterations in task-based handling of nested repetitive processes.

FIG. 16 is component block diagram illustrating an example of a computing device suitable for use with the various aspects.

FIG. 17 is component block diagram illustrating another example computing device suitable for use with the various aspects.

FIG. 18 is component block diagram illustrating an example server device suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “computing device” is used herein to refer to any one or all of cellular telephones, smartphones, personal or mobile multi-media players, personal data assistants (PDA's), personal computers, laptop computers, tablet computers, smartbooks, ultrabooks, palm-top computers, wireless electronic mail receivers, multimedia Internet enabled cellular telephones, wireless gaming controllers, desktop computers, compute servers, data servers, telecommunication infrastructure rack servers, video distribution servers, application specific servers, and similar personal or commercial electronic devices which include a memory, and one or more programmable multi-core processors.

The terms “system-on-chip” (SoC) and “integrated circuit” are used interchangeably herein to refer to a set of interconnected electronic circuits typically, but not exclusively, including multiple hardware cores, a memory, and a communication interface. The hardware cores may include a variety of different types of processors, such as a general purpose multi-core processor, a multi-core central processing unit (CPU), a multi-core digital signal processor (DSP), a multi-core graphics processing unit (GPU), a multi-core accelerated processing unit (APU), and a multi-core auxiliary processor. A hardware core may further embody other hardware and hardware combinations, such as a field programmable gate array (FPGA), an application-specific integrated circuit (ASCI), other programmable logic device, discrete gate logic, transistor logic, performance monitoring hardware, watchdog hardware, and time references. Integrated circuits may be configured such that the components of the integrated circuit reside on a single piece of semiconductor material, such as silicon. Such a configuration may also be referred to as the IC components being on a single chip.

In an aspect, a process executing in a scheduler, within or separate from an operating system, for a multi-processor or multi-core processor system may reduce the overhead of nested repetitive processes (e.g., nested loops) in task-based run-time systems employing parallel processing, across multiple processors or processor cores, of tasks including portions of the processing of an outer repetitive process (or first repetitive process) by creating shadow tasks for each task for potentially processing an inner repetitive process (or second repetitive process). In an aspect, the outer repetitive process may have a criterion to execute until an outer repetition value (or first repetition value) with a relationship to a value n is realized. The relationship between the outer repetition value and the value n may be any arithmetic or logical relationship. To employ parallel processing of the outer repetitive process, tasks may be initialized for subsets, or partitions, of the criterion. For example, if the criterion is to repeat the outer repetitive process for each value between a starting value and the value n by incrementing the outer repetition value until it equals n, then the task may be assigned a subset of the repetitions between the starting value and the value n.

The number of tasks, represented here by p, and how they are assigned their respective subsets may vary. In an aspect, the number of tasks may be equal to the number of available processors or processor cores. For example, with four available processors or processor cores (i.e., p=4), four subsets may be initialized, represented here by n0, n1, n2, and n3, and four tasks t may be initialized, represented here by t0, t1, t2, and t3. Each subset may be associated with a task t, for example, n0 with t0, n1 with t1, n2 with t2, and n3 with t3.

While each task is executed by its respective processor or processor core, there is the potential for an inner repetitive process, nested within the outer repetitive process, to be executed. In a task-based run-time system, processing the inner repetitive process would require initializing a new task each time the inner repetitive process is to be executed until an inner repetition value (or second repetition value) with a relationship to a value m is realized. As discussed above, this may potentially result in p*m initialized tasks. To avoid initializing a task for each time the inner repetitive process is to be executed, a shadow task for the inner repetitive process may be initialized for each task of the outer repetitive process. In other words, there may be p shadow tasks. Continuing with the example above, shadow task st0 may be initialized for task t0, st1 may be initialized for task t1, st2 may be initialized for task t2, and st3 may be initialized for task t3. During execution of the tasks, the computer system may store a pointer, or other type of reference, for each task to a memory location accessible by the respective shadow task and indicating the progress of the respective task. In different cases, the shadow task may or may not execute for various iterations of its respective task. With each iteration of the inner repetitive processes of the tasks, the respective pointers may be updated. By implementing the pointers accessible to the shadow tasks, the computer system may not have to delete existing shadow tasks or initialize new shadow tasks. In an aspect in which a condition exists for the shadow task to execute, the shadow task may check the pointer associated with the respective task to determine the iteration of the inner repetitive process that the respective task is executing, partition the remaining inner iterations and execute its share of the inner iteration space while the respective task works on its share of the inner iteration space. The shadow task may create new tasks to help with the inner iteration space.

In an aspect in which the task completes its iterations, i.e., the outer repetition value for the task equals a final repetition value for the task's subset of n, the processor may discard the task and its shadow task. While one task may complete, one or more of the other tasks may continue to execute. Discarding the completed task may make the respective processor or processor core that executed the completed task available for other work. While at least one task is still executing, the scheduler may further divide the subset of the executing task into one or more new subsets, or subpartitions, and initialize one or more tasks and shadow tasks to execute for the new subsets on the now available processor(s) or processor core(s). In an aspect, rather than discarding completed tasks and shadow tasks, while other tasks continue to execute, the scheduler may reassign the completed task and shadow task to a new subset of the further divided subset. When the executing task subset can no longer be subdivided, the scheduler may initialize one or more shadow tasks associated with subsets of the criterion for executing the inner repetitive process to be executed on the available processors or processor cores when the shadow task is executed.

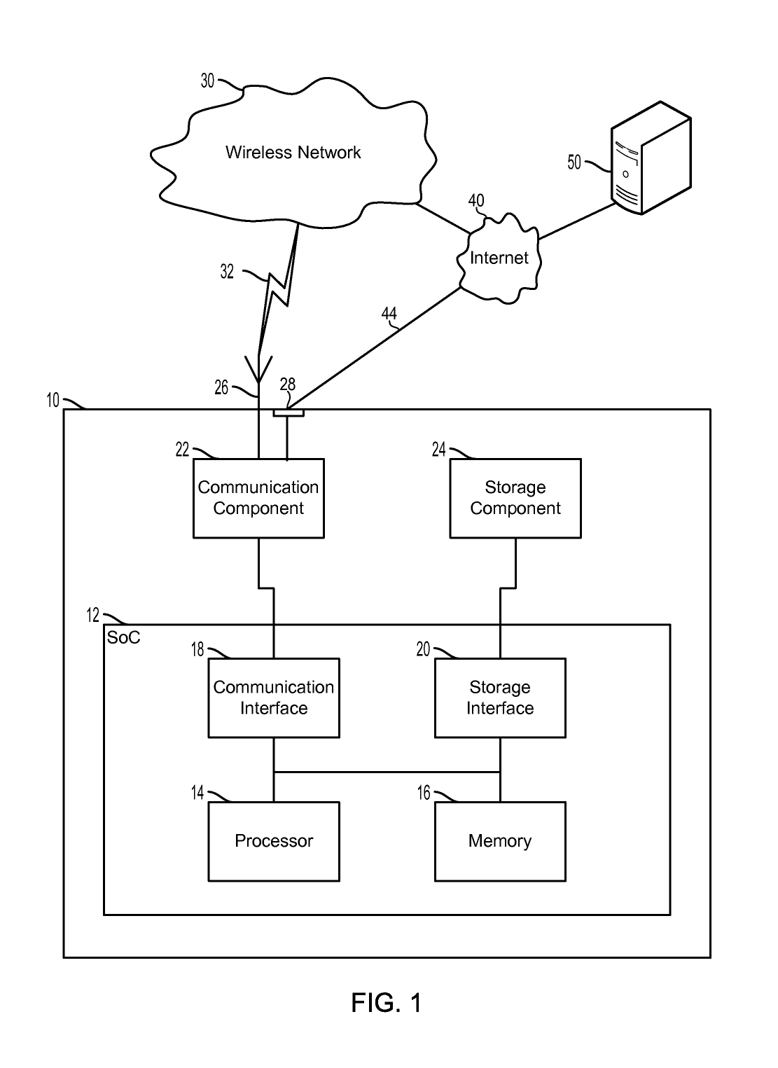

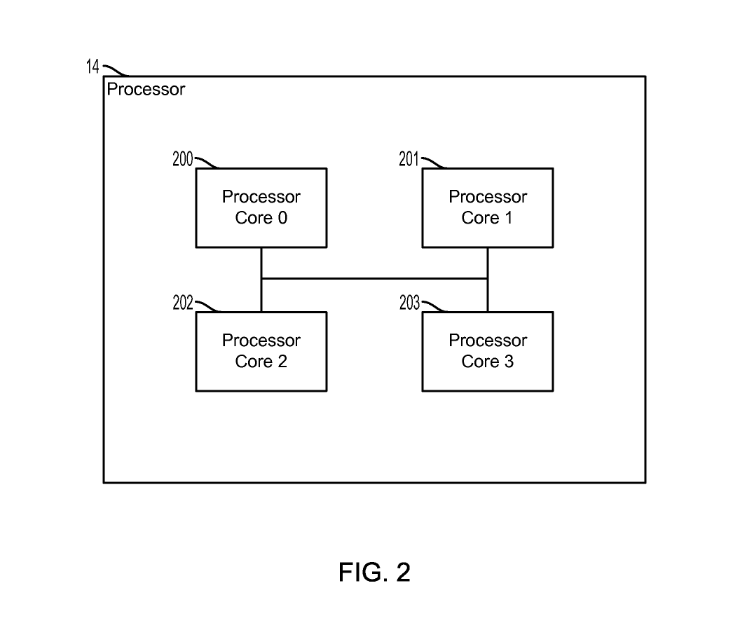

FIG. 1 illustrates a system that may implement an aspect that includes a computing device 10 that may include an SoC 12 with a processor 14, a memory 16, a communication interface 18, and a storage interface 20. The computing device may further include a communication component 22 such as a wired or wireless modem, a storage component 24, an antenna 26 for establishing a wireless connection 32 to a wireless network 30, and/or the network interface 28 for connecting to a wired connection 44 to the Internet 40. The computing device 10 may communicate with a remote computing device 50 over the wireless connection 32 and/or the wired connection 44. The processor 14 may comprise any of a variety of hardware cores as described above. The SoC 12 may include one or more processors 14. The computing device 10 may include one or more SoCs 12, thereby increasing the number of processors 14. The computing device 10 may also include processors 14 that are not associated with an SoC 12. The processors 14 may each be configured for specific purposes that may be the same or different from other processors 14 of the computing device 10. Further, individual processors 14 may be multi-core processors as described below with reference to FIG. 2.

The computing device 10 and/or SoC 12 may include one or more memories 16 configured for various purposes. The memory 16 may be a volatile or non-volatile memory configured for storing data and processor-executable code for access by the processor 14. In an aspect, the memory 16 may be configured to, at least temporarily, store data related to tasks of nested repetitive processes as described herein. As discussed in further detail below, each of the processor cores of the processor 14 may assigned a task comprising a subset, or partition, of the n iterations of the outer repetitive process by a scheduler of a high level operating system running on the computing device 10.

The communication interface 18, communication component 22, antenna 26 and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50.

The storage interface 20 and the storage component 24 may work in unison to allow the computing device 10 to store data on a non-volatile storage medium. The storage component 24 may be configured much like an aspect of the memory 16 in which the storage component 24 may store the data related to tasks of nested repetitive processes, such that the data may be accessed by one or more processors 14. The storage interface 20 may control access the storage device 24 and allow the processor 14 to read data from and write data to the storage device 24.

It should be noted that some or all of the components of the computing device 10 may be differently arranged and/or combined while still serving the necessary functions. Moreover, the computing device 10 may not be limited to one of each of the components, and multiple instances of each component, in various configurations, may be included in the computing device 10

FIG. 2 illustrates a multi-core processor 14 suitable for implementing an aspect. The multi-core processor 14 may have a plurality of processor cores 200, 201, 202, 203. In an aspect, the processor cores 200, 201, 202, 203 may be equivalent processor cores in that, processor cores 200, 201, 202, 203 of a single processor 14 may be configured for the same purpose and to have the same performance characteristics. For example, the processor 14 may be a general purpose processor, and the processor cores 200, 201, 202, 203 may be equivalent general purpose processor cores. Alternatively, the processor 14 may be a graphics processing unit or a digital signal processor, and the processor cores 200, 201, 202, 203 may be equivalent graphics processor cores or digital signal processor cores, respectively. Through variations in the manufacturing process and materials, it may result that the performance characteristics of the processor cores 200, 201, 202, 203 may differ from processor core to processor core, within the same multi-core processor 14 or in another multi-core processor 14 using the same designed processor cores. In an aspect, the processor cores 200, 201, 202, 203 may include a variety of processor cores that are nonequivalent. For example, some of the processor cores 200, 201, 202, 203 may be configured for the same or different purposes and to have the same or different performance characteristics. In an aspect, the processor cores 200, 201, 202, 203 may include a combination of equivalent and nonequivalent processor cores.

In the example illustrated in FIG. 2, the multi-core processor 14 includes four processor cores 200, 201, 202, 203, (i.e., processor core 0, processor core 1, processor core 2, and processor core 3). For ease of explanation, the examples herein may refer to the four processor cores 200, 201, 202, 203 illustrated in FIG. 2. However, it should be noted that FIG. 2 and the four processor cores 200, 201, 202, 203 illustrated and described herein are in no way meant to be limiting. The computing device 10, the SoC 12, or the multi-core processor 14 may individually or in combination include fewer or more than the four processor cores 200, 201, 202, 203.

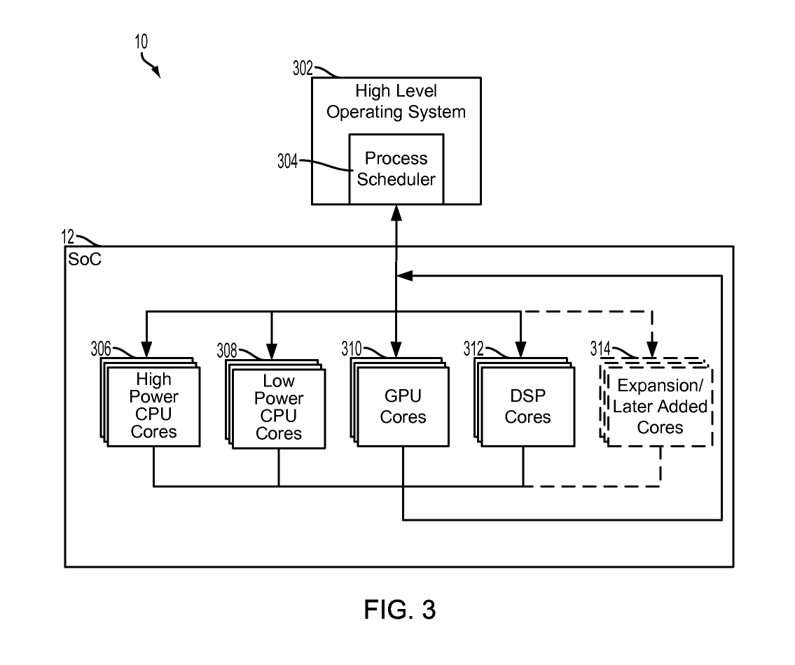

FIG. 3 illustrates a computing device 10 having an SoC 12 including multiple processor cores 306, 308, 310, 312, 314. The computing device 10 may also include a high level operating system 302, which may be configured to communicate with the components of the SoC 12 and operate a process or task scheduler 304 for managing the processes or tasks assigned to the various processor cores 306, 308, 310, 312, 314. In various aspects, the task scheduler 304 may be a part of or separate from the high level operating system 302.

In FIG. 3, different types of multi-core processors are illustrated, including a high performance/high leakage multi-core general purpose/central processing unit (CPU) 306 (referred to as a “high power CPU core” in the figure), a low performance/low leakage multi-core general purpose/central processing unit (CPU) 308 (referred to as a “low power CPU core” in the figure), a multi-core graphics processing unit (GPU) 310, a multi-core digital signal processor (DSP) 312, and other multi-core computational units 314.

FIG. 3 also illustrates that processor cores 314 may be installed in the computing device after it is sold, such as an expansion or enhancement of processing capability or as an update to the computing device. After-market expansions of processing capabilities are not limited to central processor cores, and may be any type of computing module that may be added to or replaced in a computing system, including for example, additional, upgraded or replacement modem processors, additional or replacement graphics processors (GPUs), additional or replacement audio processors, and additional or replacement DSPs, any of which may be installed as single-chip-multi-core modules or clusters of processors (e.g., on an SoC). Also, in servers, such added or replaced processor components may be installed as processing modules (or blades) that plug into a receptacle and wiring harness interface.

Each of the groups of processor cores illustrated in FIG. 3 may be part of a multi-core processor 14 as described above. Moreover, these five example multi-core processors (or groups of processor cores) are not meant to be limiting, and the computing device 10 or the SoC 12 may individually or in combination include fewer or more than the five multi-core processors 306, 308, 310, 312, 314 (or groups of processor cores), including types not displayed in FIG. 3.

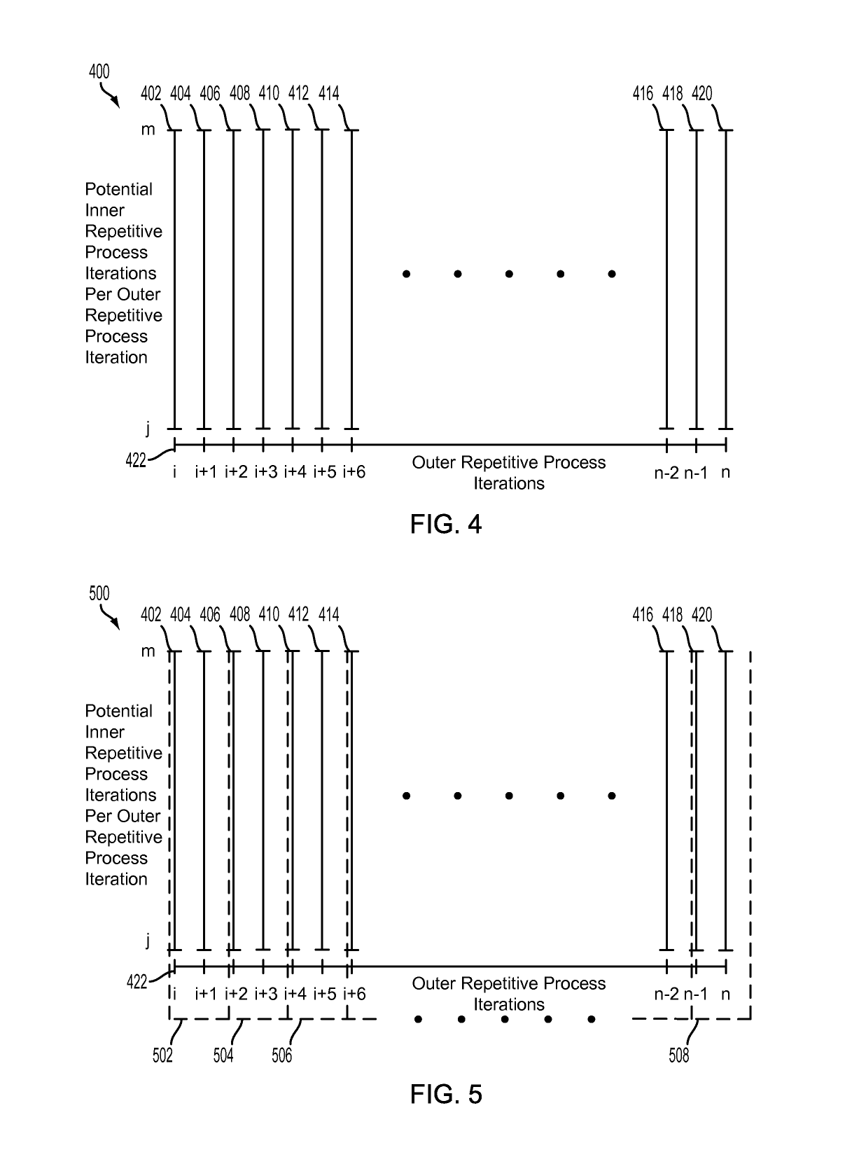

FIG. 4 illustrates an aspect task-based handling of nested repetitive processes. Graph 400 illustrates one outer repetitive process 422 comprising multiple iterations i through n. At each iteration there is a possibility of executing an inner repetitive process 402, 404, 406, 408, 410, 412, 414, 416, 418, 420 (or 402-420). Each inner repetitive process 402-420 may comprise multiple iterations j through m. The number of iterations of the outer repetitive process 422 and the number of iterations of the inner repetitive processes 402-420 may vary depending on various factors. For any iteration of the outer repetitive process 422, the respective inner repetitive process 402-420 may or may not execute depending on various factors. The graph 400 illustrates only one outer repetitive process 422 for purposes of simplicity of explanation, but it should be noted that the number of the inner and outer repetitive processes and iterations thereof are not limited by the examples used in the descriptions herein.

FIG. 5 illustrates an aspect task-based handling of nested repetitive processes. Graph 500 illustrates the same graph as graph 400 in FIG. 4 with the addition of multiple partitions 502, 504, 506, 508 of the outer repetitive process 422. As illustrated, partition 502 includes iterations i and i+1 of the outer repetitive process 422. Further, partition 504 includes iterations i+2 and i+3, partition 506 includes iterations i+4 and i+5, and partition 508 includes iterations n−1 and n. These partitions 502, 504, 506, 508 are divided into equal numbers of iterations of the outer repetitive process 422 for ease of explanation, but it should be noted that partitions the outer repetitive processes need not be equal in size and the number of partitions may vary. The task scheduler (see FIG. 3) may partition the iterations of the outer repetitive process and assign each partition to a different processor or processor core. In doing so, the computing device may process the partitions 502, 504, 506, 508 in parallel. The scheduler may determine the size of various partitions and to which processor or processor core to assign each partition based on various criteria, for example, the type, the performance characteristics, and/or the availability of the processor or processor core, and/or the type, the resource requirements, and/or the latency tolerance of the execution of outer repetitive processes.

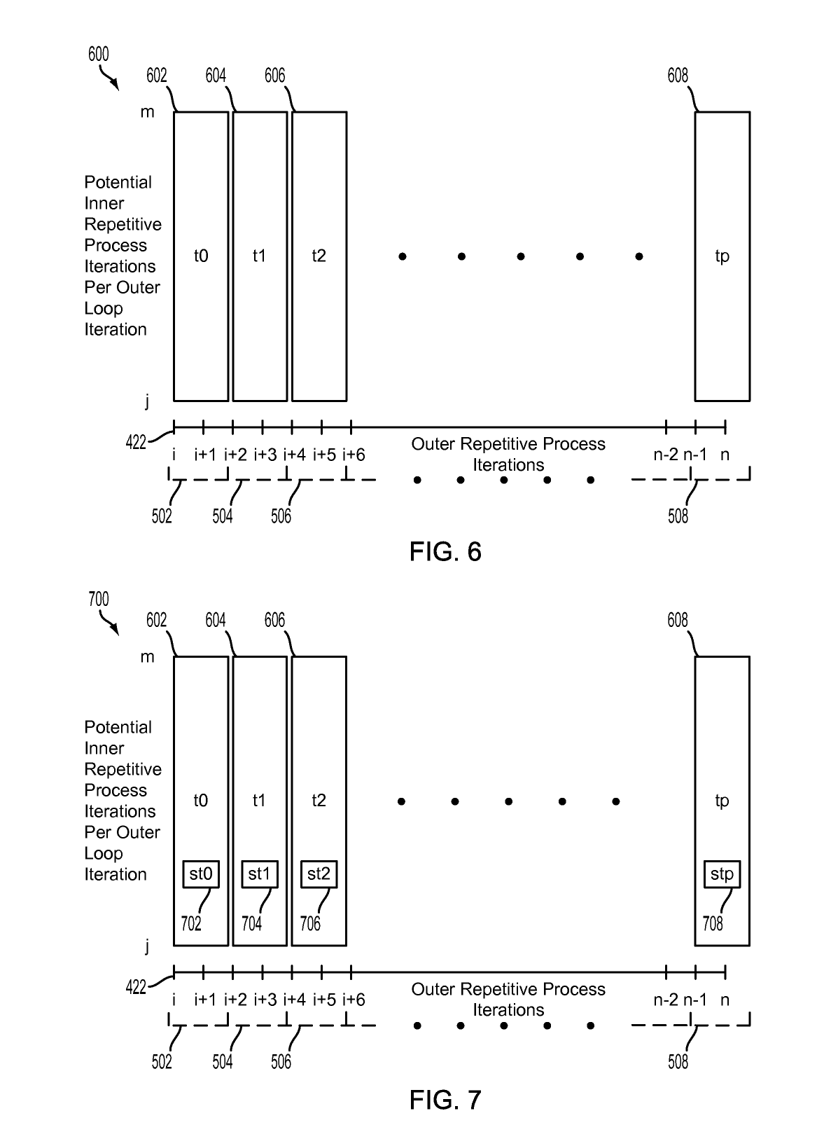

FIG. 6 illustrates an aspect task-based handling of nested repetitive processes. Graph 600 illustrates the same graph as graph 500 in FIG. 5 with the addition of multiple tasks t0 602, t1 604, t2 606, and tp 608. In a task-based run-time system, the processor may be assigned tasks or create tasks for executing assigned processes. The number of tasks, represented here by p, and how they are assigned their respective partitions may vary. In an aspect, each of the tasks 602, 604, 606, 608 may be initialized and may involve executing the iterations of one of the partitions 502, 504, 506, 508 of the outer repetitive process 422 (i.e., p=4), and any iterations of a related inner repetitive process. For example, task t0 602 may involve executing the iterations i and i+1 of partition 502 of the outer repetitive process 422. Similarly, task t1 604 may involve executing the iterations i+2 and i+3 of partition 504, task t2 606 may involve executing the iterations i+4 and i+5 of partition 506, and task tp 608 may involve executing the iterations n−1 and n of partition 508.

In an aspect, the number of tasks may be equal to the number of partitions, as described above, or to the number available processors or processor cores. For example, with four available processors or processor cores (see FIG. 2) (i.e., p=4), four tasks 602, 604, 606, 608 may be initialized. Each task 602, 604, 606, 608 may be associated with a processor or processor core. For example, task t0 602 may be associated with processor core 0, task t1 604 processor core 1, task t2 606 with processor core 1, and task tp 608 with processor core 3.

FIG. 7 illustrates an aspect task-based handling of nested repetitive processes. Graph 700 illustrates the same graph as graph 600 in FIG. 6 with the addition of multiple shadow tasks st0 702, st1 704, st2 706, and stp 708. For each task of a partition of an outer repetitive process identified to include or potentially include an inner repetitive process, a shadow task may be initialized for executing the inner repetitive process. For example, for task t0 602, which comprises the partition 502 of the outer repetitive process 422 having iterations i and i+1, the shadow task st0 702 may be initialized for potentially executing the inner repetitive tasks (see FIG. 5) of task t0 602 when conditions for executing the inner repetitive tasks are met. Similarly, shadow task st1 704 may be initialized for task t1 604, shadow task st2 706 may be initialized for task t2 606, and shadow task stp 708 may be initialized for task tp 608. In an aspect, a shadow tasks may be initialized for each task upon identification or a first execution of an inner repetitive process of the respective task. In an aspect, a shadow task may be initialized for each task after initialization of the respective task, regardless of whether an inner repetitive process exists or may be executed for the respective task.

In an aspect, a shadow task may execute the iterations of the inner repetitive process on a different processor or processor core from the related task, while the related task executes and the different processor or processor core is available. In an aspect, a task may execute all of the iterations of the outer repetitive process and inner repetitive process before a processor or processor core becomes available to execute the related shadow task, and the related shadow task may not execute any iterations of the inner repetitive task.

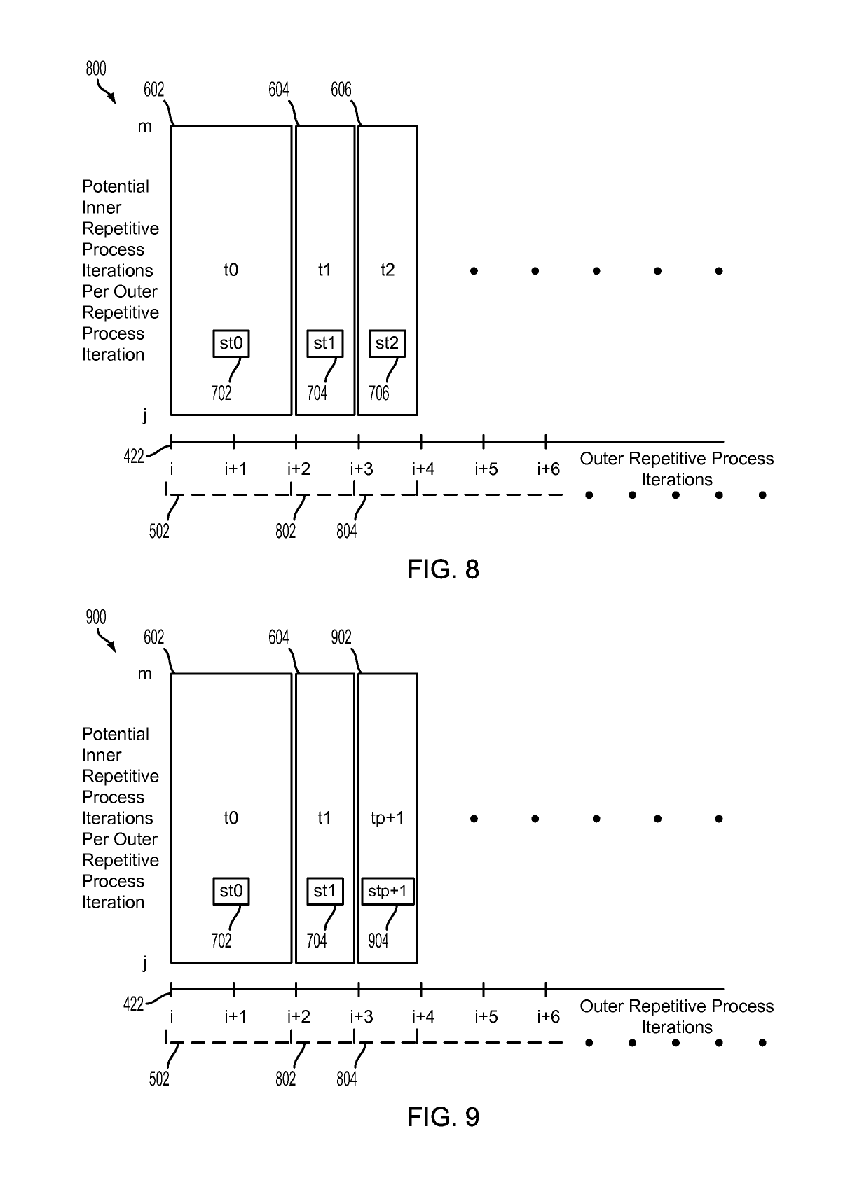

FIG. 8 illustrates an aspect task-based handling of nested repetitive processes. Graph 800 illustrates a cropped portion of the same graph as graph 700 in FIG. 7 after the completion of at least one of the tasks, including the completion of the shadow tasks if executed. Upon completion of a task or completion of the iterations assigned to the task, the processor or processor core which executed the task may be available for executing further tasks. The remaining tasks having more than one iteration of the respective partition of the outer repetitive process to execute may be reassigned a subpartition of the respective partition, and the completed task may be assigned another subpartition of the same partition. For example, in FIG. 8 task t2 606 has completed. In other word, t2 606 has completed the iterations i+4 and i+5 of its respective partition 506 of the outer repetitive process 422 (see FIG. 7). In this example, task t1 604 is still executing its first iteration of its respective partition 504 of the outer repetitive process 422, and its second iteration has not been executed (see FIG. 7). Therefore, the partition 504 assigned to task t1 604 is divisible (see FIG. 7), and, in an aspect, the partition 504 (see FIG. 7) may be divided into subpartitions 802, 804. Task t1 604 may be reassigned the subpartition 802 comprising the iteration i+2 of the outer repetitive process 422 to complete executing the iteration. The completed task t2 606 may be reassigned the subpartition 804 comprising the iteration i+3 of the outer repetitive process 422, which was previously part or the partition 504 assigned to task t1 604 (see FIG. 7). Thus, in an aspect, a partition assigned to a task, where the task has yet to begin executing at least the last iteration of the partition, may be split into subpartitions so that one or more of the yet to be executed iterations of the partition may be reassigned to an available processor or processor core to increase the speed of executing the iterations of an outer repetitive process.

FIG. 9 illustrates an aspect task-based handling of nested repetitive processes. Graph 900 illustrates the same graph as graph 800 in FIG. 8, except that rather than reassigning a subpartition to a completed task, a new task and shadow task are initialized to execute the subpartition. In an aspect, when a task completes executing, including the completion of a respective shadow task if executed, the task and the shadow task may be discarded. Upon completing the task, the processor or processor core assigned the completed task may be available to execute additional tasks. For example, in FIG. 9 task t2 606 has completed. In other word, t2 606 has completed the iterations i+4 and i+5 of its respective partition 506 of the outer repetitive process 422 (see FIG. 7). In this example, task t1 604 is still executing its first iteration of its respective partition 504 of the outer repetitive process 422, and its second iteration has not been executed (see FIG. 7). Therefore, the partition 504 assigned to task t1 604 is divisible (see FIG. 7) and, in an aspect, the partition 504 (see FIG. 7) may be divided into subpartitions 802, 804. Task t1 604 may be reassigned the subpartition 802 comprising the iteration i+2 of the outer repetitive process 422 to complete executing the iteration. In this example, completed task t2 and shadow task st2 are discarded, therefore task tp+1 902 may be initialized for the subpartition 804 comprising the iteration i+3 of the outer repetitive process 422, which was previously part of the partition 504 assigned to task t1 604 (see FIG. 7), and assigned to the available processor or processor core. Further, in the same manner as discussed herein, a shadow task stp+1 904 may be initialized to potentially execute an inner repetitive process for the task tp+1 902. Thus, in an aspect, a partition assigned to a task, where the task has yet to begin executing at least the last iteration of the partition, may be split into subpartitions so that one or more of the yet to be executed iterations of the partition may be reassigned to an available processor or processor core to increase the speed of executing the iterations of an outer repetitive process.

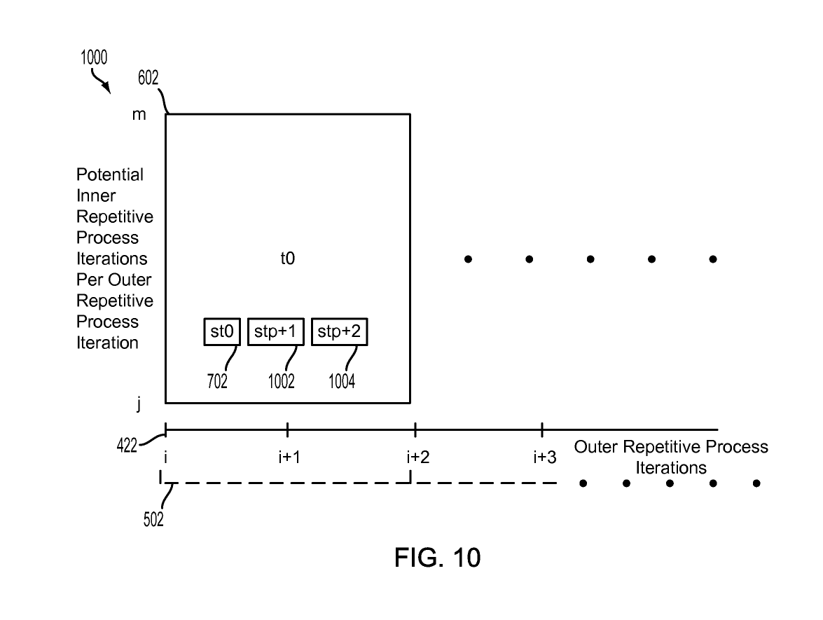

FIG. 10 illustrates an aspect task-based handling of nested repetitive processes. Graph 1000 illustrates a cropped portion of the same graph as graph 700 in FIG. 7 after the completion of all but one of the tasks, including the completion of the respective shadow tasks if executed. The iterations of this final task may also be indivisible. In other words, the task may be executing the last remaining iteration of its respective partition of an outer repetitive process. When the iterations of the final task are not divisible, available processors or processor cores may not be able to be assigned further iterations of the outer repetitive process. Rather, in an aspect, the available processors or processor cores may be assigned the existing shadow task related to the remaining task and new shadow tasks to help execute iterations of inner repetitive processes of the final iteration of the final task. For example, task t0 602 may be a final executing task from a set of tasks, such as tasks t0, t1, t2, and tp (see FIG. 7). The completion of three of the four tasks in this example may indicate the availability of three processors or processor cores. In an aspect, where the task t0 602 has completed iteration i of its respective partition 502, and is executing the final iteration i+1 of its respective partition 502, the iterations of the task t0 602 may not be able to be further divided into subpartitions. However, there is potential for an inner repetitive process to require significant processing, and thus, to help complete the execution of the last task, additional shadow tasks may be initialized, such as shadow task stp+1 1002 and shadow task stp+2 1004. The existing shadow task st0 702 and the additional shadow tasks 1002, 1004 may be assigned partitions of the iterations of the inner repetitive process. The iterations of the inner repetitive process may be determined in much that same way as the partitions of the iterations of the outer repetitive process as described herein. The number of additional shadow tasks initialized may depend on the partitions of the iterations of the inner repetitive process, and/or the number of available processors or processor cores. In an aspect, the existing shadow task may be assigned to an available processor or processor core for execution. Thus, continuing with the example, in a circumstance where three processors or processor cores are available, existing shadow task st0 702 may be assigned to one of the processors or processor cores, leaving two processors or processor cores available. The new shadow tasks stp+1 1002 and stp+2 1004 may be assigned to the remaining two processor or processor cores.

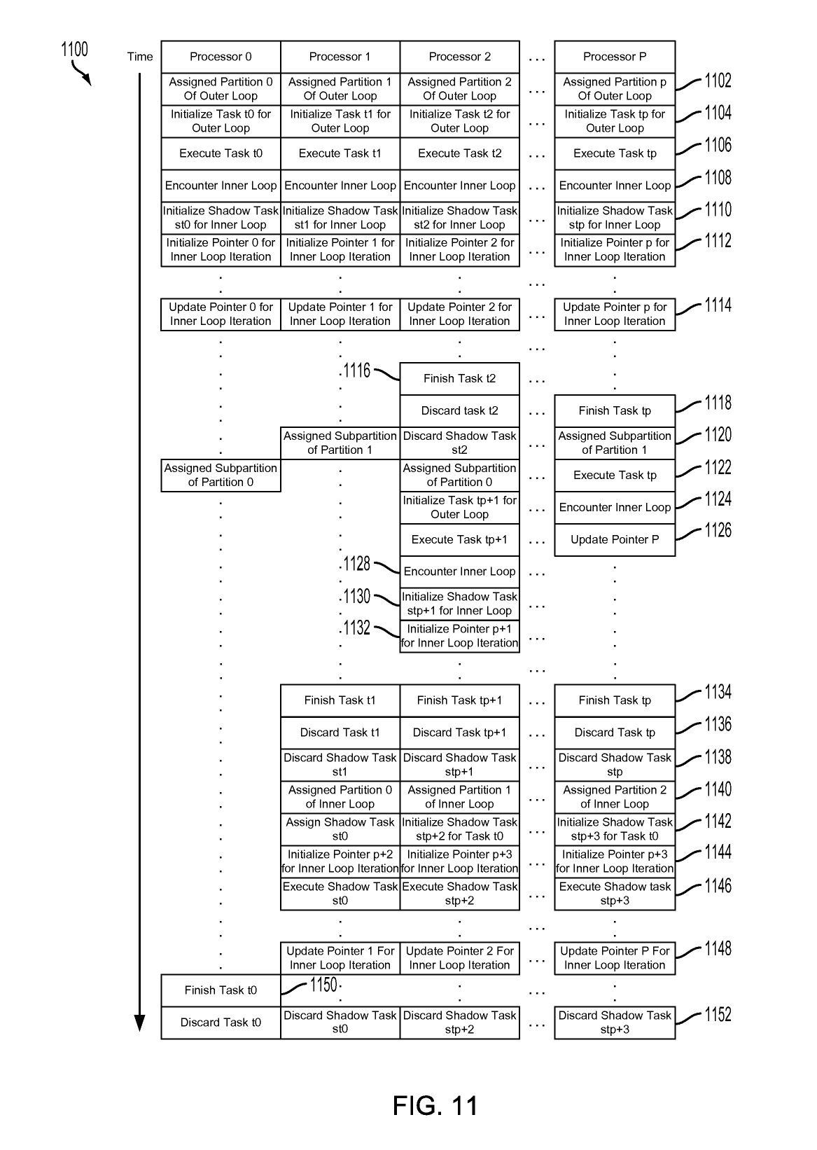

FIG. 11 illustrates an example in chart 1100 of task-based handling of nested repetitive processes. Chart 1100 illustrates an example time progression of the states of four processors or processor cores, processor 0, processor 1, processor 2, and processor p, implementing task-based handling of nested repetitive processes. The use of four processors or processor cores in this example is not meant to be limiting, and similar task-based handling of nested repetitive processes may be implemented using more or fewer than four processors or processor cores. In row 1102 of chart 1100 in this example, each of the processors or processor cores may be assigned a respective partition of iterations of an outer repetitive process, or outer loop. Processor 0 may be assigned partition 0, processor 1 may be assigned partition 1, processor 2 may be assigned partition 2, and processor p may be assigned partition p. In row 1104, tasks may be initialized for executing the iterations of the respective partitions of the outer repetitive process assigned to each processor or processor core. In this example, task t0 may be initialized for partition 0 and processor 0, task t1 may be initialized for partition 1 and processor 1, task t2 may be initialized for partition 2 and processor 2, and task tp may be initialized for partition p and processor p.

In row 1106, each of the processors or processor cores may begin to execute their respective tasks. Executing the tasks may include executing the assigned partitions of the iterations of the outer repetitive processes and the associated inner repetitive processes. In an aspect, as described further herein, a shadow task of the respective tasks may help execute the iterations of the associated inner repetitive processes when hardware resources are available. In row 1108, the processors or processor cores may encounter inner repetitive processes for respective tasks. Upon encountering the inner repetitive process for the first time during the execution of each task, in row 1110, each of the processors or processor cores may initialize a shadow task for a respective task, the shadow task being initialized for potentially executing the inner repetitive process, or inner loop, of the outer repetitive process. The shadow task may be initialized regardless of whether the shadow task executes or not. In this example, shadow task st0 may be initialized for task t0 and processor 0, shadow task st1 may be initialized for task t1 and processor 1, shadow task st2 may be initialized for task t2 and processor 2, and shadow task stp may be initialized for task tp and processor p. In an aspect, a shadow task may be initialized whenever a task is executed in anticipation of potentially executing an inner repetitive process, regardless of whether an inner repetitive process exists. In another aspect, a shadow task may be initialized whenever an inner repetitive process is identified for a task, either before or upon encountering the inner repetitive process during execution of the task. For each task, one shadow task may suffice, and the shadow task may be executed multiple times depending on whether multiple iterations of the partition of the outer repetitive process of the task require the execution of the inner repetitive process. In an aspect, one shadow task may be initialized to handle multiple inner repetitive processes, or multiple shadow tasks may be initialized to handle one or more inner repetitive processes.

Also upon encountering the inner repetitive task for the first time during the execution of each task, in row 1112, a pointer, or other reference type, may be initialized for the respective task. In this example, pointer 0 may be initialized for task t0, pointer 1 may be initialized for task t1, pointer 2 may be initialized for task t2, and pointer p may be initialized for task tp. The pointers may be used to track the progress of the execution of the inner repetitive processes for their respective tasks, and the pointers may be accessible by shadow tasks for use in determining when to execute the shadow tasks and for which iteration of the inner repetitive process, as described further herein. In an aspect, a pointer may be initialized for each of one or more inner repetitive processes for each task. The shadow task may access the pointer of the respective task to identify the inner repetitive process iteration of the task when instructed to execute. In row 1114, the processors or processor cores may update the respective pointers to indicate the start or completion of execution of the inner repetitive processes of the respective tasks. Throughout the execution of the tasks, the pointers may be repeatedly updated to indicate the iteration of the inner repetitive processes for the iteration of the outer repetitive processes being executed.

Several of the states in the above described rows 1108, 1110, 1112, 1114 may be repeated to complete execution of the tasks for all of the iterations of the respective partitions of the outer repetitive process and all the iterations of one or more inner repetitive processes on each of the processors or processor cores. Depending on various factors, such as size of the partitions, characteristics of the processors or processor cores, and number of executions of the inner repetitive process, one or more of the tasks may complete executing at the same or different times. For example, in rows 1116 and 1118, tasks t2 and tp finish executing, while the remaining tasks, in this example t0 and t1, may continue to execute. As described herein, after completing the execution of a task, the processor or processor core may become available for further processing, and various schemes may be implemented to engage the available processor or processor core with further task execution.

In this example, processor 2 and processor p may implement different schemes. The scheme for processor 2 may include discarding the completed task t2 in row 1118. Again, depending on the implemented scheme for processor 2, the related shadow task st2 in row 1120 may be discarded when there are no iterations of the inner repetitive process for the respective shadow task to execute. In row 1122, processor 2 may be assigned a subpartition of one of the ongoing tasks being executed by another of the processors or processor cores. The subpartition may be one or more iterations of the outer repetitive process that has yet to be executed by one of the ongoing tasks. The partition of the remaining iterations of the ongoing task may be divided into two or more subpartitions, and the subpartitions may be assigned to tasks. Particularly, one of the subpartitions may be assigned to the original task of the partition, and the other subpartition(s) may be assigned to other new or existing but completed tasks. In this example, partition 0 of ongoing task t0 being executed on processor 0 may include unexecuted iterations of the outer repetitive process. Partition 0 may be divided into two subpartitions, one of which may be assigned to processor 0 and task t0, and the other may be assigned to processor 2 and a newly initialized task tp+1 in rows 1122 and 1124. Much like above, in row 1126, processor 2 may begin executing task tp+1, encounter an inner repetitive processes for the respective task in row 1128, initialize a shadow task stp+1 for task tp+1 in row 1130, and initialize a pointer, or other reference type, for the respective task in row 1132. In an aspect, initializing the point may involve initializing a new pointer for the task, or updating the existing pointer. Also as described above, during the execution of task tp+1, the respective pointer for task tp+1 may be updated for the current or last executed iteration of the inner repetitive process.

The scheme for processor p differs from the scheme for processor 2 described above, in that rather than discarding the completed task and shadow task, and initializing a new task and shadow task to execute a subpartition of the iterations of the outer repetitive process, processor p uses the existing completed task and shadow task. In this example, partition 1 of ongoing task t1 being executed on processor 1 may include unexecuted iterations of the outer repetitive process. Partition 1 may be divided into two subpartitions, one of which may be assigned to processor 1 and task t1, and the other may be assigned to processor p and existing completed task tp in row 1120. Much like above, in row 1122 processor p may begin executing task tp for the subpartition, encounter an inner repetitive process in row 1124, and update the respective pointer for the iteration of the inner repetitive process for task tp in row 1126. In this example scheme, there is no need to initialize a new pointer or shadow task, as they both may exist from the previous execution of task tp, however one or both of a new pointer and new shadow task may be initialized if so desired. In an aspect, when the previous execution of task tp did not result in initializing a pointer and shadow task, a pointer, or other reference type, and shadow task may be initialized upon encountering the inner repetitive process during this execution of task tp.

For the respective scheme implemented to engage the available processor or processor core with further task execution, several of the states in the above described rows 1124, 1126, 1128, 1130, and 1132 may be repeated to complete execution of the tasks for all of the iterations of the respective subpartitions of the outer repetitive process and the related inner repetitive processes on each of the processors or processor cores. Depending on various factors, such as the ones described above, one or more of the tasks may complete executing at the same or different times. For example, in row 1134, tasks t1, tp+1, and tp may finish executing, while task t0 may continue to execute. In an aspect, where only one ongoing task remains and the ongoing task is executing the final iteration of its partition of the iterations of the outer repetitive process, the partition cannot be subpartitioned to assign iterations of the outer repetitive process to the available processors or processor cores like in rows 1120 and 1122 described above. However, it may be possible to reassign the existing shadow task for the ongoing task to an available processor or processor core, and initialize extra shadow tasks for the ongoing task to aid in executing the iterations of the inner repetitive process. Continuing with the example in FIG. 11, the completed tasks from row 1134, task t1, task tp+1 and task tp, may be discarded in row 1136, and their respective shadow tasks, shadow task st1, shadow task stp+1 and shadow task stp, may also be discarded in row 1138. Because task t0 is ongoing, but does not include a divisible number of remaining iterations of the outer repetitive process, much like assigning partitions and initializing tasks in rows 1102 and 1104 described above, in rows 1140 and 1142, partitions of the iterations of the inner repetitive process may be assigned to an available processor or processor core and extra shadow tasks may be initialized for task to. Also in row 1142, the existing shadow task for the ongoing task may be assigned to an available processor or processor core. In this example, shadow task stp+2 may be initialized for task t0 and to execute partition 1 on processor 2, and shadow task stp+3 may be initialized for task t0 and to execute partition 2 on processor p. Also, the original shadow task st0 of task t0 may be assigned partition 0 to execute on processor 1. In an aspect, in row 1144, each of the shadow tasks may initialize pointers, or other references, to track the progress of the execution of the inner repetitive processes by each of the shadow tasks. Much like described above, in row 1146, the shadow tasks may only execute when conditions are met to execute the inner repetitive process. In row 1148 the shadow tasks may update respective pointers to keep track of the started or completed iterations of the inner repetitive process. In an aspect, the shadow tasks may also update the pointer for task to.

While the final ongoing task continues to execute its last iteration, several of the states in the above described rows 1146 and 1148 may be repeated to aid in executing the iterations of the inner repetitive process when necessary. In row 1150 the final ongoing task, task t0 in this example, may complete its execution. With no remaining outer or inner repetitive process iterations, task t0 and shadow tasks may be discarded in row 1152.

It should be noted that the various described states of the processors or processor cores may occur in a different order than in the examples described herein. The descriptions of FIGS. 4-11 are not meant to be limiting as to the order or number of processors or processor cores, states, tasks, shadow tasks, partitions, subpartitions, pointers or other reference types, iterations, processes, or any other element described herein.

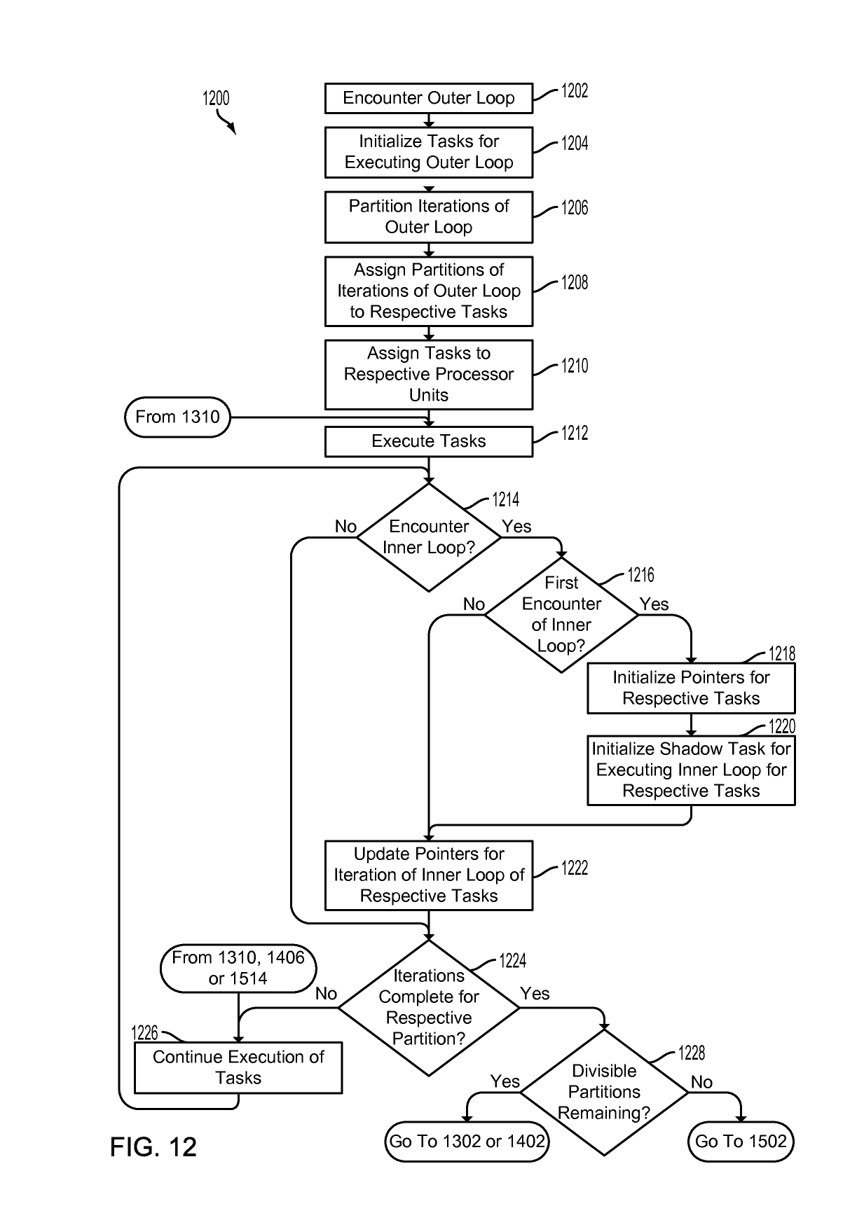

FIG. 12 illustrates an aspect method 1200 for task-based handling of nested repetitive processes. The method 1200 may be executed by one or more processors or processor cores of the computing device. While running programs in a task-based run-time system, in block 1202 the processor or processor core may encounter an outer repetitive process, or outer loop, of a nested repetitive process in a program. In block 1204 one or more tasks may be initialized for executing the outer repetitive process in parallel across multiple processors or processor cores. The number of tasks initialized to execute the outer repetitive process may vary. In an aspect, the number of tasks initialized may be equal to a number of available processors or processor cores to which the tasks may be assigned as further described below. In other aspects, the number of tasks may be determined by one or more factors including characteristics of the processors or processor cores, characteristics of the program and/or the nested repetitive process, and states of the computing device, including temperature and power availability.

In block 1206 the iterations of the outer repetitive process may be divided into partitions for execution as part of the initialized tasks in parallel on the multiple processors or processor cores. In an aspect, the number of partitions may be determined by the number of initialized tasks, or available processors or processor cores. The make up of each partition may be determined by various factors including characteristics of the processors or processor cores, characteristics of the program and/or the nested repetitive process, and states of the computing device, including temperature and power availability. The partitions may equally as possible divide the number of iterations of the outer repetitive process, or the partitions may be unequal in number of iterations of the outer repetitive process.

In block 1208 the partitions of the outer repetitive process may be assigned to respective tasks. In block 1210 the initialized tasks, and thereby the respective partitioned iterations of the outer repetitive process, may be assigned to respective processors or processor cores. Much like initializing the tasks and partitioning the iterations, assignments to particular processors or processor cores may be determined by various factors including characteristics of the processors or processor cores, characteristics of the program and/or the nested repetitive process, and states of the computing device, including temperature and power availability. In block 1212, the assigned tasks may begin executing in parallel on the respective processors or processor cores to which the task are assigned.

During the execution of an iteration of the outer repetitive process of a task, an inner repetitive process may be encountered. In determination block 1214, the processor or processor core may determine whether an inner repetitive loop is encountered. In response to determining that an inner repetitive process has not been encountered (i.e., determination block 1214=“No”), the processor or processor cores may determine whether the iterations of the outer repetitive process for a respective task are complete in determination block 1224. In response to determining that an inner repetitive process is encountered (i.e., determination block 1214=“Yes”), the processor or processor cores may determine whether it is the first encounter of the inner repetitive process for the task in determination block 1216. In response to determining that the encountered inner repetitive process is encountered for the first time for the executing task (i.e., determination block 1216=“Yes”), the processor or processor core may initialize a pointer, or other type of reference, in block 1218 for each task encountering the inner repetitive process. The pointer may be accessible by its respective task and a respective shadow task. The pointer may be used to track the iterations of the inner repetitive processes so that the respective tasks and shadow tasks know which iterations of the inner repetitive process to execute. The processor or processor cores may initialize a shadow task for the executing task, in block 1220, so that the shadow task may potentially execute the iterations of the inner repetitive process when processing resources are available. In block 1222, the respective pointers for the tasks may be updated to reflect changes in the iterations of the inner repetitive processes of the executing tasks, such as completion or starting of an iteration if the inner repetitive processes. In response to determining that it is not the first encounter of the inner repetitive process (i.e., determination block 1216=“No”), the respective pointers for the tasks may be updated in block 1222 as described above.

In an aspect, rather than determining whether an inner repetitive process is encountered and/or determining it is the first encounter of the inner repetitive process for an executing task before initializing the shadow task, the shadow task and pointer, or other reference type, may be initialized along with or shortly after initialization of the related task. Therefore, in an aspect, determination block 1216 may be obviated, and blocks 1218 and 1220 may execute regardless of the presence of an inner repetitive process. In such an aspect, in response to determining that an inner repetitive process is encountered (i.e. determination block 1214=“Yes”), the pointers may be updated in block 1222 as described above.

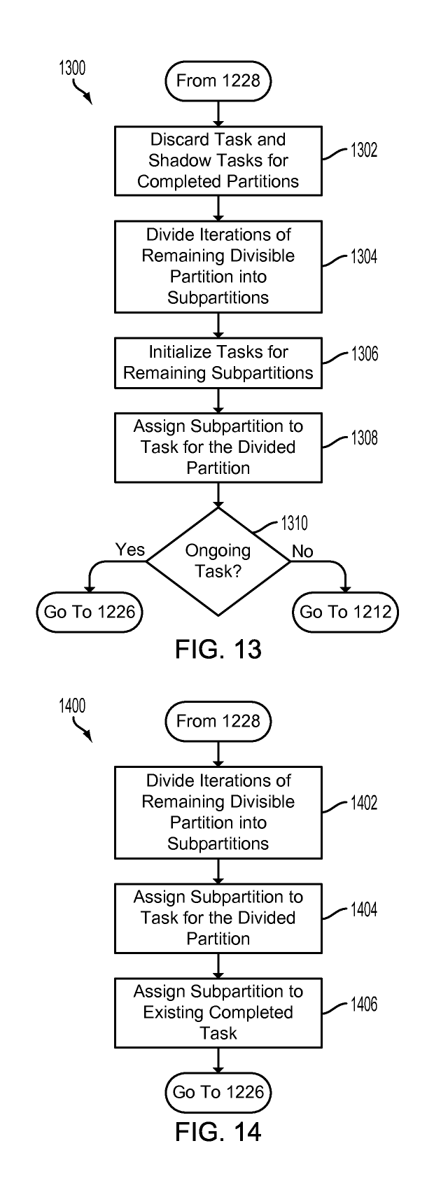

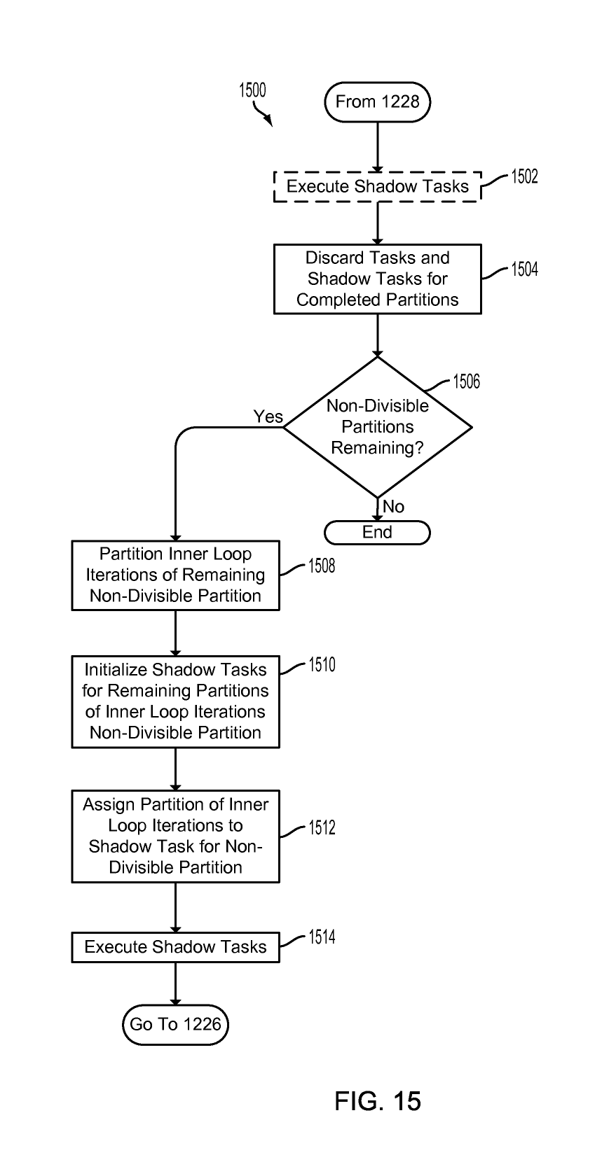

In determination block 1224, the processor or processor core may determine whether the iterations of the outer repetitive process for a respective task are complete. In response to determining that the iterations of the outer repetitive process for a respective task are incomplete, or there are remaining iterations for execution, (i.e., determination block 1224=“No”), the processor or processor core may continue to execute the respective task in block 1226, and again check whether an inner repetitive process is encountered in determination block 1214. In response to determining that the iterations of the outer repetitive process for a respective task are complete, or there are no remaining iterations for execution, (i.e., determination block 1224=“Yes”), in determination block 1228 the processor or processor core may determine whether the remaining iterations for another respective task are divisible. In determining whether the remaining iterations for the other respective task are divisible, the remaining iterations may be divisible when more than the executing iteration remain to be executed. The remaining iterations may be indivisible when only the executing iteration for the other respective task remains. In response to determining that the remaining iterations for the other respective task are divisible (i.e., determination block 1228=“Yes”), depending on the implemented scheme the processor or processor core may divide the remaining iterations of the outer repetitive process into subpartitions as described below in either method 1300 (see FIG. 13) or method 1400 (see FIG. 14). In response to determining that the remaining iterations for the other respective task are indivisible (i.e., determination block 1228=“No”), the processor or processor core may proceed to divide iterations of an inner repetitive process of the other respective task as described below in method 1500 (see FIG. 15).

FIG. 13 illustrates an aspect method 1300 for dividing a partition of outer repetitive process iterations into subpartitions in task-based handling of nested repetitive processes. The method 1300 may be executed by one or more processors or processor cores of the computing device. As described above with reference to FIG. 12, the method 1300 may be invoked in response to determining that the iterations of the outer repetitive process for a respective task are complete (i.e., determination block 1224=“Yes”) and that the remaining iterations for another respective task are divisible (i.e., determination block 1228=“Yes”). In other words, method 1300 may be invoked when a task running on a processor or processor core completes its execution and another task running on another processor or processor core is ongoing and has more iterations than just the executing iteration remaining.

In block 1302, the completed task and its completed, related shadow task may be discarded. In block 1304, the iterations of the ongoing task may be divided into subpartitions of the partition of iterations assigned to the ongoing task. For example, a partition of iterations of an outer repetitive process assigned to a task may include 500 iterations. In such an example, the ongoing task may have executed 174 iterations, and the task may be executing the 175^{th} iteration, leaving 325 iterations yet to be executed. With resources, such as processor and processor cores being available to aid in executing these remaining iterations of the task, the remaining 325 iterations may be divided into subpartitions of the original 500 iteration partition or what is now the 325 remaining iterations partition. In this example, one or more processors or processor cores may be available, and the remaining 325 iterations may be divided up in any manner over any number of the available processors or processor cores. For instance, the remaining iterations may be divided equally or unequally over the available processors or processor cores, and it is possible that at least one available processor or processor core is not assigned a subpartition of the remaining iterations. Further, the processor or processor core executing the task with the remaining iterations may be assigned at least the executing iteration of the task at the time the remaining iterations are divided. How the remaining iterations are divided into subpartitions may depend on a variety of factors including characteristics of the processors or processor cores (e.g., relative processing speed, relative power efficiency/current leakage, etc.), characteristics of the program and/or the nested repetitive process, and states of the computing device, including temperature and power availability (e.g., on-battery or charging).

In block 1306 tasks may be initialized for the remaining unassigned subpartitions. In block 1308 one subpartition may be assigned to the ongoing task for which the iterations are being divided. Thus, all of the subpartitions get assigned to either the existing ongoing task or a newly initialized task for executing on the available processor(s) or process core(s).

In determination block 1310, the processor or processor core may determine whether the task is an ongoing task or a new task. In response to determining that the task is an ongoing task (i.e., determination block 1310=“Yes”), the processor or processor core executing the ongoing task may continue executing the task in block 1226 (see FIG. 12). In response to determining that the task is not an ongoing task (i.e., determination block 1310=“No”), and thus is a new task, the processor or processor core assigned to execute the new task may execute the task in block 1212 as described above with reference to FIG. 12.

FIG. 14 illustrates an aspect method 1400 for dividing a partition of outer repetitive process iterations into subpartitions for task-based handling of nested repetitive processes. The method 1400 may be executed by one or more processors or processor cores of the computing device. As described above with reference to FIG. 12, the method 1400 may be invoked in response to determining that the iterations of the outer repetitive process for a respective task are complete (i.e., determination block 1224=“Yes”) and that the remaining iterations for another respective task are divisible (i.e., determination block 1228=“Yes”). In other words, method 1400 may be invoked when a task running on a processor or processor core completes its execution, and another task running on another processor or processor core is ongoing and has more iterations than just the executing iteration remaining. This is similar to the method 1300 described with reference FIG. 13; however, rather than discard the competed tasks and shadow tasks, as in block 1302 (see FIG. 13), the respective processors or processor cores may retain the completed tasks and shadow tasks to execute for reassigned iterations of the outer repetitive process.

In block 1402, the remaining iterations of an ongoing task may be divided into subpartitions much like in block 1304 described above with reference to FIG. 13. In block 1404, one of the subpartitions containing portions of the remaining iterations of the ongoing task may be assigned to the ongoing task to complete executing a reduced portion of its original partition of the iterations of the outer repetitive process. In block 1406, the remaining unassigned subpartitions may be assigned to the existing completed tasks. Thus, all of the subpartitions get assigned to either the existing ongoing task or an existing completed task for executing on the available processor(s) or process core(s). The processor or processor core for executing each task may proceed to continue executing the task in block 1226 as described above with reference to FIG. 12.

FIG. 15 illustrates an aspect method 1500 for partitioning inner repetitive process iterations in task-based handling of nested repetitive processes. The method 1500 may be executed by one or more processors or processor cores of the computing device. As described above with reference to FIG. 12, the method 1500 may be invoked in response to determining that the iterations of the outer repetitive process for a respective task are complete (i.e., determination block 1224=“Yes”) and that the remaining iterations for another respective task are indivisible (i.e., determination block 1228=“No”). In other words, method 1500 may be invoked when a task running on a processor or processor core completes its execution, and another task running on another processor or processor core is ongoing, but the ongoing task only has the executing iteration remaining.

The completed task may have freed up processing resources, like one of the processors or processor cores for execution of other tasks or shadow tasks. In optional block 1502, the shadow task of a completed task may execute on the available processor or processor core; however, there may be no iterations if the inner repetitive processes remaining for execution. In block 1504, the completed task and its completed, related shadow task may be discarded. In determination block 1506, the processor or processor core may determine whether any ongoing tasks are executing indivisible partitions. As described above, an indivisible partition of iterations is a partition containing only the executing iteration of the outer repetitive process. In response to determining that both no divisible partitions and no indivisible partitions remain (i.e., determination block 1506=“No”), method 1500 may end. In response to determining that at least one indivisible partition remains (i.e., determination block 1506=“Yes”), inner repetitive process iterations of the ongoing task may be partitioned in block 1508 in much the same way as the iterations of the outer repetitive process in block 1206 described above with reference to FIG. 12. In block 1510, new shadow tasks may be initialized for the partitions of the inner repetitive process of the remaining ongoing task. In block 1512, the partitions of the inner repetitive process may be assigned to a respective shadow task, including the existing shadow task and the newly initialized shadow tasks. In block 1514, the processor or processor core assigned a shadow task may execute the shadow task for the partition of the inner repetitive processes of the ongoing task. The processor or processor core may continue to execute the ongoing task in block 1226 as described above with reference to FIG. 12.

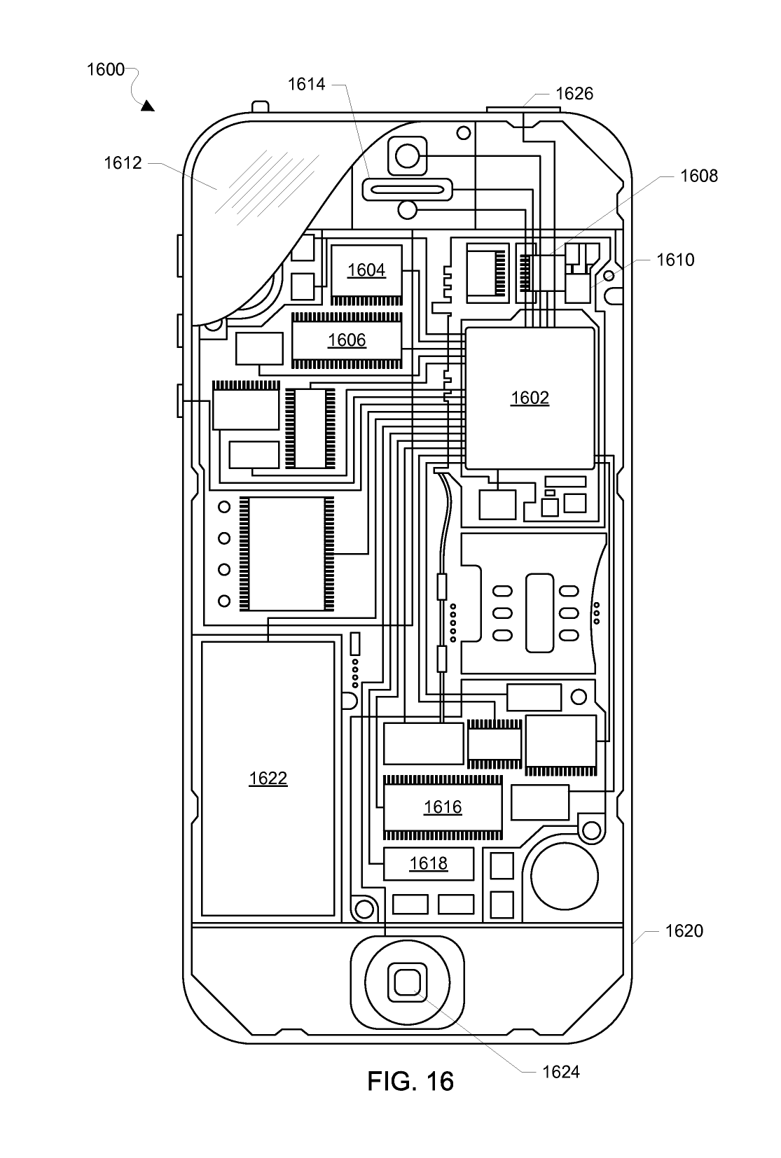

FIG. 16 illustrates an example of a computing device suitable for implementing the various aspects in the form of a smartphone. A smartphone computing device 1600 may include a multi-core processor 1602 coupled to a touchscreen controller 1604 and an internal memory 1606. The multi-core processor 1602 may be one or more multi-core integrated circuits designated for general or specific processing tasks. The internal memory 1606 may be volatile or non-volatile memory, and may also be secure and/or encrypted memory, or unsecure and/or unencrypted memory, or any combination thereof. The touchscreen controller 1604 and the multi-core processor 1602 may also be coupled to a touchscreen panel 1612, such as a resistive-sensing touchscreen, capacitive-sensing touchscreen, infrared sensing touchscreen, etc. Additionally, the display of the computing device 1600 need not have touch screen capability.

The smartphone computing device 1600 may have one or more radio signal transceivers 1608 (e.g., Peanut, Bluetooth, Zigbee, Wi-Fi, RF radio) and antennae 1610, for sending and receiving communications, coupled to each other and/or to the multi-core processor 1602. The transceivers 1608 and antennae 1610 may be used with the above-mentioned circuitry to implement the various wireless transmission protocol stacks and interfaces. The smartphone computing device 1600 may include a cellular network wireless modem chip 1616 that enables communication via a cellular network and is coupled to the processor.

The smartphone computing device 1600 may include a peripheral device connection interface 1618 coupled to the multi-core processor 1602. The peripheral device connection interface 1618 may be singularly configured to accept one type of connection, or may be configured to accept various types of physical and communication connections, common or proprietary, such as USB, FireWire, Thunderbolt, or PCIe. The peripheral device connection interface 1618 may also be coupled to a similarly configured peripheral device connection port (not shown).

The smartphone computing device 1600 may also include speakers 1614 for providing audio outputs. The smartphone computing device 1600 may also include a housing 1620, constructed of a plastic, metal, or a combination of materials, for containing all or some of the components discussed herein. The smartphone computing device 1600 may include a power source 1622 coupled to the multi-core processor 1602, such as a disposable or rechargeable battery. The rechargeable battery may also be coupled to the peripheral device connection port to receive a charging current from a source external to the smartphone computing device 1600. The smartphone computing device 1600 may also include a physical button 1624 for receiving user inputs. The smartphone computing device 1600 may also include a power button 1626 for turning the smartphone computing device 1600 on and off.

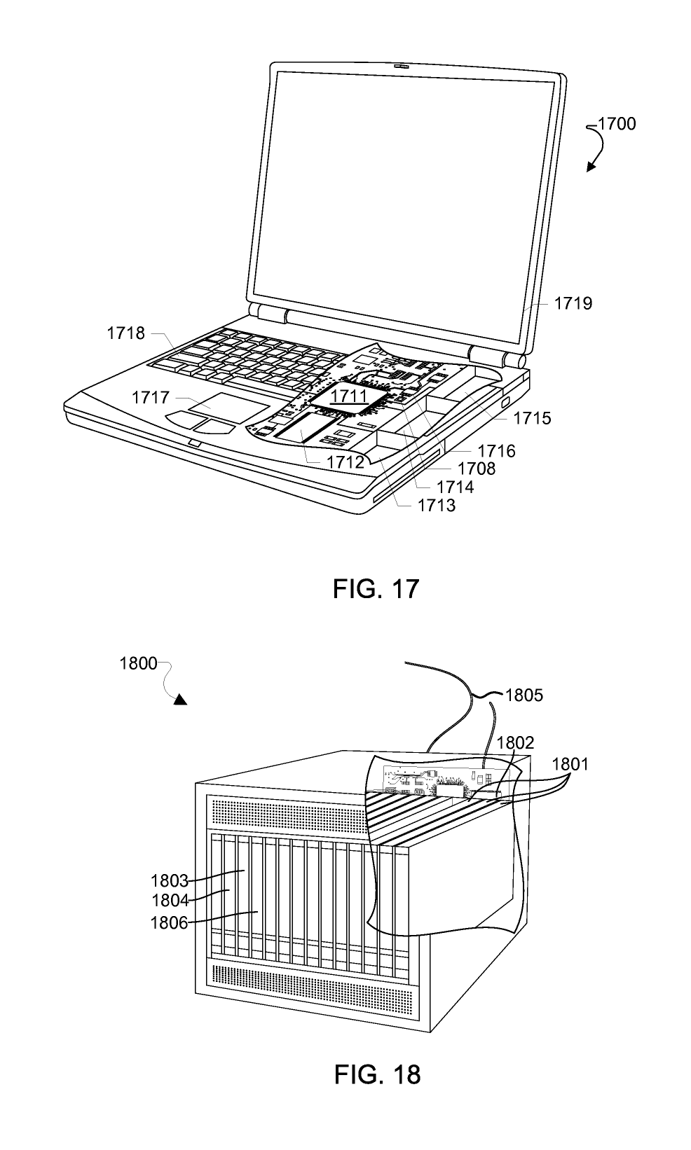

The various aspects described above may also be implemented within a variety of other computing devices, such as a laptop computer 1700 illustrated in FIG. 17. Many laptop computers include a touchpad touch surface 1717 that serves as the computer's pointing device, and thus may receive drag, scroll, and flick gestures similar to those implemented on computing devices equipped with a touch screen display and described above. A laptop computer 1700 will typically include a multi-core processor 1711 coupled to volatile memory 1712 and a large capacity nonvolatile memory, such as a disk drive 1713 of Flash memory. Additionally, the computer 1700 may have one or more antenna 1708 for sending and receiving electromagnetic radiation that may be connected to a wireless data link and/or cellular telephone transceiver 1716 coupled to the multi-core processor 1711. The computer 1700 may also include a floppy disc drive 1714 and a compact disc (CD) drive 1715 coupled to the multi-core processor 1711. In a notebook configuration, the computer housing includes the touchpad 1717, the keyboard 1718, and the display 1719 all coupled to the multi-core processor 1711. Other configurations of the computing device may include a computer mouse or trackball coupled to the processor (e.g., via a USB input) as are well known, which may also be use in conjunction with the various aspects. A desktop computer may similarly include these computing device components in various configurations, including separating and combining the components in one or more separate but connectable parts.

The various aspects may also be implemented on any of a variety of commercially available server devices, such as the server 1800 illustrated in FIG. 18. Such a server 1800 typically includes one or more multi-core processor assemblies 1801 coupled to volatile memory 1802 and a large capacity nonvolatile memory, such as a disk drive 1804. As illustrated in FIG. 18, multi-core processor assemblies 1801 may be added to the server 1800 by inserting them into the racks of the assembly. The server 1800 may also include a floppy disc drive, compact disc (CD) or DVD disc drive 1806 coupled to the processor 1801. The server 1800 may also include network access ports 1803 coupled to the multi-core processor assemblies 1801 for establishing network interface connections with a network 1805, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many computing devices operating system kernels are organized into a user space (in which non-privileged code runs) and a kernel space (in which privileged code runs). This separation is of particular importance in Android and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc, wherein disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of task-based handling of nested repetitive processes, comprising:
partitioning iterations of an outer repetitive process into a first plurality of outer partitions;
initializing a first task for executing iterations of a first outer partition;
initializing a first shadow task for executing iterations of an inner repetitive process for the first task;
initializing a second task for executing iterations of a second outer partition;
executing the first task by a first processor core and the second task by a second processor core in parallel; and
executing the first shadow task for the iterations of the inner repetitive process each time a condition calls for executing the inner repetitive process upon availability of the second processor core and assignment to the second processor core.

2. The method of claim 1, further comprising:
completing execution of the second task;
determining whether the first outer partition is divisible; and
partitioning the first outer partition of the first task into a second plurality of outer partitions in response to determining that the first outer partition is divisible.

3. The method of claim 2, further comprising:
assigning a third outer partition of the second plurality of outer partitions to the first task;
assigning a fourth outer partition of the second plurality of outer partitions to the second task;
executing the first task on the third outer partition by the first processor core and the second task on the fourth outer partition by the second processor core in parallel;
completing execution of the second task a subsequent time resulting in availability of the second processor core; and
assigning the first shadow task to the second processor core.

4. The method of claim 2, further comprising:
discarding the second task;
initializing a third task for executing iterations of a fourth outer partition of the second plurality of outer partitions;
assigning a third outer partition of the second plurality of outer partitions to the first task;
assigning the fourth outer partition of the second plurality of outer partitions to the third task;
executing the first task on the third outer partition by the first processor core and the third task on the fourth outer partition by the second processor core in parallel;
completing execution of the third task resulting in availability of the second processor core; and
assigning the first shadow task to the second processor core.

5. The method of claim 2, wherein completing execution of the second task results in availability of the second processor core, the method further comprising:
determining whether the inner repetitive process of the first task is divisible in response to determining that the first outer partition of the outer repetitive process is indivisible;
partitioning the iterations of the inner repetitive process into a first plurality of inner partitions in response to determining that the inner repetitive process of the first task is divisible;
assigning the iterations of the inner repetitive process to the first shadow task, wherein the iterations of the inner repetitive process comprise a first inner partition; and
assigning the first shadow task to the second processor core.

6. The method of claim 5, further comprising:
initializing a second shadow task for executing the iterations of the inner repetitive process for the first task upon availability of a third processor core;
assigning a second inner partition to the second shadow task;
assigning the second shadow task to the third processor core; and
executing the second shadow task for iterations of the second inner partition of the inner repetitive process each time a condition calls for executing the inner repetitive process.

7. The method of claim 5, further comprising partitioning the iterations of the inner repetitive process by a number of partitions equivalent to a number of available processor cores.

8. The method of claim 1, further comprising partitioning the iterations of the outer repetitive process by a number of partitions equivalent to a number of available processor cores.

9. The method of claim 1, further comprising:
initializing a first pointer for the first task;
updating the first pointer to indicate execution of the iterations of the inner repetitive process of the first outer partition; and
checking the first pointer to determine an iteration of the inner repetitive process of the first outer partition for executing by the first shadow task.

10. A computing device, comprising:
a plurality of processor cores at least one of which is configured with processor-executable instructions to perform operations comprising:
partitioning iterations of an outer repetitive process into a first plurality of outer partitions;
initializing a first task for executing iterations of a first outer partition;
initializing a first shadow task for executing iterations of an inner repetitive process for the first task;
initializing a second task for executing iterations of a second outer partition;
executing the first task by a first processor core and the second task by a second processor core in parallel; and
executing the first shadow task for the iterations of the inner repetitive process each time a condition calls for executing the inner repetitive process upon availability of the second processor core and assignment to the second processor core.

11. The computing device of claim 10, wherein at least one of the plurality of processor cores is configured with processor-executable instructions to perform operations further comprising:
completing execution of the second task;
determining whether the first outer partition is divisible; and
partitioning the first outer partition of the first task into a second plurality of outer partitions in response to determining that the first outer partition is divisible.

12. The computing device of claim 11, wherein at least one of the plurality of processor cores is configured with processor-executable instructions to perform operations further comprising:
assigning a third outer partition of the second plurality of outer partitions to the first task;
assigning a fourth outer partition of the second plurality of outer partitions to the second task;
executing the first task on the third outer partition by the first processor core and the second task on the fourth outer partition by the second processor core in parallel;
completing execution of the second task a subsequent time resulting in availability of the second processor core; and
assigning the first shadow task to the second processor core.

13. The computing device of claim 11, wherein at least one of the plurality of processor cores is configured with processor-executable instructions to perform operations further comprising:
discarding the second task;
initializing a third task for executing iterations of a fourth outer partition of the second plurality of outer partitions;
assigning a third outer partition of the second plurality of outer partitions to the first task;
assigning the fourth outer partition of the second plurality of outer partitions to the third task;
executing the first task on the third outer partition by the first processor core and the third task on the fourth outer partition by the second processor core in parallel;
completing execution of the third task resulting in availability of the second processor core; and
assigning the first shadow task to the second processor core.

14. The computing device of claim 11, wherein at least one of the plurality of processor cores is configured with processor-executable instructions to perform operations such that completing execution of the second task results in availability of the second processor core, and to perform operations further comprising:
determining whether the inner repetitive process of the first task is divisible in response to determining that the first outer partition of the outer repetitive process is indivisible;
partitioning the iterations of the inner repetitive process into a first plurality of inner partitions in response to determining that the inner repetitive process of the first task is divisible;
assigning the iterations of the inner repetitive process to the first shadow task, wherein the iterations of the inner repetitive process comprise a first inner partition; and
assigning the first shadow task to the second processor core.

15. The computing of claim 14, wherein at least one of the plurality of processor cores is configured with processor-executable instructions to perform operations further comprising:
initializing a second shadow task for executing the iterations of the inner repetitive process for the first task upon availability of a third processor core;
assigning a second inner partition to the second shadow task;
assigning the second shadow task to the third processor core; and
executing the second shadow task for iterations of the second inner partition of the inner repetitive process each time a condition calls for executing the inner repetitive process.

16. The computing device of claim 14, wherein at least one of the plurality of processor cores is configured with processor-executable instructions to perform operations further comprising partitioning the iterations of the inner repetitive process by a number of partitions equivalent to a number of available processor cores.

17. The computing device of claim 10, wherein at least one of the plurality of processor cores is configured with processor-executable instructions to perform operations further comprising: partitioning the iterations of the outer repetitive process by a number of partitions equivalent to a number of available processor cores.

18. The computing device of claim 10, wherein at least one of the plurality of processor cores is configured with processor-executable instructions to perform operations further comprising:
initializing a first pointer for the first task;
updating the first pointer to indicate execution of the iterations of the inner repetitive process of the first outer partition; and
checking the first pointer to determine an iteration of the inner repetitive process of the first outer partition for executing by the first shadow task.

19. A non-transitory processor-readable medium having stored thereon processor-executable software instructions to cause at least one of a plurality of processor cores to perform operations comprising:
partitioning iterations of an outer repetitive process into a first plurality of outer partitions;
initializing a first task for executing iterations of a first outer partition;
initializing a first shadow task for executing iterations of an inner repetitive process for the first task;
initializing a second task for executing iterations of a second outer partition;
executing the first task by a first processor core and the second task by a second processor core in parallel; and
executing the first shadow task for the iterations of the inner repetitive process each time a condition calls for executing the inner repetitive process upon availability of the second processor core and assignment to the second processor core.

20. The non-transitory processor-readable medium of claim 19, wherein the stored processor-executable software instructions are configured to cause at least one of the plurality of processor cores to perform operations further comprising:
completing execution of the second task;
determining whether the first outer partition is divisible; and
partitioning the first outer partition of the first task into a second plurality of outer partitions in response to determining that the first outer partition is divisible.

21. The non-transitory processor-readable medium of claim 20, wherein the stored processor-executable software instructions are configured to cause at least one of the plurality of processor cores to perform operations further comprising:
assigning a third outer partition of the second plurality of outer partitions to the first task;
assigning a fourth outer partition of the second plurality of outer partitions to the second task;
executing the first task on the third outer partition by the first processor core and the second task on the fourth outer partition by the second processor core in parallel;
completing execution of the second task a subsequent time resulting in availability of the second processor core; and
assigning the first shadow task to the second processor core.

22. The non-transitory processor-readable medium of claim 20, wherein the stored processor-executable software instructions are configured to cause at least one of the plurality of processor cores to perform operations further comprising:
discarding the second task;
initializing a third task for executing iterations of a fourth outer partition of the second plurality of outer partitions;
assigning a third outer partition of the second plurality of outer partitions to the first task;
assigning the fourth outer partition of the second plurality of outer partitions to the third task;
executing the first task on the third outer partition by the first processor core and the third task on the fourth outer partition by the second processor core in parallel;
completing execution of the third task resulting in availability of the second processor core; and
assigning the first shadow task to the second processor core.

23. The non-transitory processor-readable medium of claim 20, wherein the stored processor-executable software instructions are configured to cause at least one of the plurality of processor cores to perform operations such that completing execution of the second task results in availability of the second processor core, and to perform operations further comprising:
determining whether the inner repetitive process of the first task is divisible in response to determining that the first outer partition of the outer repetitive process is indivisible;
partitioning the iterations of the inner repetitive process into a first plurality of inner partitions in response to determining that the inner repetitive process of the first task is divisible;
assigning the iterations of the inner repetitive process to the first shadow task, wherein the iterations of the inner repetitive process comprise a first inner partition; and
assigning the first shadow task to the second processor core.

24. The non-transitory processor-readable medium of claim 23, wherein the stored processor-executable software instructions are configured to cause at least one of the plurality of processor cores to perform operations further comprising:
initializing a second shadow task for executing the iterations of the inner repetitive process for the first task upon availability of a third processor core;
assigning a second inner partition to the second shadow task;
assigning the second shadow task to the third processor core; and
executing the second shadow task for iterations of the second inner partition of the inner repetitive process each time a condition calls for executing the inner repetitive process.

25. The non-transitory processor-readable medium of claim 23, wherein the stored processor-executable software instructions are configured to cause at least one of the plurality of processor cores to perform operations further comprising partitioning the iterations of the inner repetitive process by a number of partitions equivalent to a number of available processor cores.

26. The non-transitory processor-readable medium of claim 19, wherein the stored processor-executable software instructions are configured to cause at least one of the plurality of processor cores to perform operations further comprising partitioning the iterations of the outer repetitive process by a number of partitions equivalent to a number of available processor cores.

27. The non-transitory processor-readable medium of claim 19, wherein the stored processor-executable software instructions are configured to cause at least one of the plurality of processor cores to perform operations further comprising:
initializing a first pointer for the first task;
updating the first pointer to indicate execution of the iterations of the inner repetitive process of the first outer partition; and
checking the first pointer to determine an iteration of the inner repetitive process of the first outer partition for executing by the first shadow task.

28. A computing device, comprising:
means for partitioning iterations of an outer repetitive process into a first plurality of outer partitions;
means for initializing a first task for executing iterations of a first outer partition;
means for initializing a first shadow task for executing iterations of an inner repetitive process for the first task;
means for initializing a second task for executing iterations of a second outer partition;
means for executing the first task by a first processor core and the second task by a second processor core in parallel; and
means for executing the first shadow task for the iterations of the inner repetitive process each time a condition calls for executing the inner repetitive process upon availability of the second processor core and assignment to the second processor core.

29. The computing device of claim 28, further comprising:
means for completing execution of the second task;
means for determining whether the first outer partition is divisible; and
means for partitioning the first outer partition of the first task into a second plurality of outer partitions in response to determining that the first outer partition is divisible.

30. The computing device of claim 29, further comprising:
means for assigning a third outer partition of the second plurality of outer partitions to the first task;
means for assigning a fourth outer partition of the second plurality of outer partitions to the second task;
means for executing the first task on the third outer partition by the first processor core and the second task on the fourth outer partition by the second processor core in parallel;
means for completing execution of the second task a subsequent time resulting in availability of the second processor core; and
means for assigning the first shadow task to the second processor core.

31. The computing device of claim 29, further comprising:
means for discarding the second task;
means for initializing a third task for executing iterations of a fourth outer partition of the second plurality of outer partitions;
means for assigning a third outer partition of the second plurality of outer partitions to the first task;
means for assigning the fourth outer partition of the second plurality of outer partitions to the third task;
means for executing the first task on the third outer partition by the first processor core and the third task on the fourth outer partition by the second processor core in parallel;
means for completing execution of the third task resulting in availability of the second processor core; and
means for assigning the first shadow task to the second processor core.

32. The computing device of claim 29, wherein means for completing execution of the second task results in availability of the second processor core, the computing device further comprising:
means for determining whether the inner repetitive process of the first task is divisible in response to determining that the first outer partition of the outer repetitive process is indivisible;
means for partitioning the iterations of the inner repetitive process into a first plurality of inner partitions in response to determining that the inner repetitive process of the first task is divisible;
means for assigning the iterations of the inner repetitive process to the first shadow task, wherein the iterations of the inner repetitive process comprise a first inner partition; and
means for assigning the first shadow task to the second processor core.

33. The computing device of claim 32, further comprising:
means for initializing a second shadow task for executing the iterations of the inner repetitive process for the first task upon availability of a third processor core;
means for assigning a second inner partition to the second shadow task;
means for assigning the second shadow task to the third processor core; and
means for executing the second shadow task for iterations of the second inner partition of the inner repetitive process each time a condition calls for executing the inner repetitive process.

34. The computing device of claim 32, further comprising means for partitioning the iterations of the inner repetitive process by a number of partitions equivalent to a number of available processor cores.

35. The computing device of claim 28, further comprising means for partitioning the iterations of the outer repetitive process by a number of partitions equivalent to a number of available processor cores.

36. The computing device of claim 28, further comprising:
means for initializing a first pointer for the first task;
means for updating the first pointer to indicate execution of the iterations of the inner repetitive process of the first outer partition; and
means for checking the first pointer to determine an iteration of the inner repetitive process of the first outer partition for executing by the first shadow task.
